(19) United States
(12) Patent Application Publication
(10) Pub. No.: US 2011/0008025 A1
(43) Pub. Date: Jan. 13, 2011

(54) METHOD AND APPARATUS FOR GENERATING COMPOUND PLASMA, AND ELECTRO-THERMAL COOKING APPARATUS USING THE COMPOUND PLASMA

(76) Inventor: Byeng Chul Lee, Seoul (KR)

Correspondence Address: ROBERTS MLOTKOWSKI SAFRAN & COLE, P.C.;Intellectual Property Department, P.O. Box 10064, MCLEAN, VA, 22102-8064, US

(21) Appl. No.: 12/920,308

(22) PCT Filed: Feb. 26, 2009
(86) PCT No.: PCT/KR09/00923

§ 371 Date: Aug. 30, 2010

(30) Foreign Application Priority Data
Mar. 3, 2008 (KR) 10-2008-0019694

(51) Int. Cl. F24C 11/00; H05H 1/48

(52) U.S. Cl. 392/307; 204/164; 422/186.04

(57) ABSTRACT

Disclosed are method and apparatus for generating compound plasma and electro-thermal cooking apparatus using the compound plasma. An electro-thermal cooking apparatus has an evaporator for generating water vapor by heating water therein with electric energy, a blast nozzle for blasting the water vapor supplied from the evaporator, and an electric discharge means, installed in an insulating body around the blast nozzle, for making the water vapor electrically discharged by applying strong energy to the water vapor blasted from the blast nozzle so as to convert the water vapor into compound plasma of hydrogen plasma and oxygen plasma. The compound plasma is used as an energy transfer medium for a cooking utensil. According to the present invention, efficiency of heat transfer is improved because the compound plasma of high temperature of which energy density is relatively high is used, although it employs electrically heating method. The heating time can also be reduced even with a downsized device.

### TECHNICAL FIELD

The present invention is related to a method and an apparatus for producing plasma. In particular, the present invention is drawn to a method and an apparatus for generating compound plasma of oxygen and hydrogen using water vapor as a raw material. The present invention is also directed to an electro-thermal cooking apparatus using the compound plasma generated by the compound plasma production apparatus as a medium for transferring thermal energy.

### BACKGROUND ART

Heating apparatuses using gas have been widely used as cooking apparatuses in most homes as a kitchen is close to a living room. Particularly in apartments, the city gas is used as fuel for the heating apparatuses, whereas electric type heating apparatuses for cooking are used restrictively.

Gas type heating apparatuses generate a great amount of gas when a fuel gas combusts. The gas forms a flow of high speed around the outer surface of a cooking utensil and thus improves a heat transfer rate a lot compared with a natural convection. Due to that, efficiency of heat transfer increases, and therefore a heating time is shortened.

Pipe lines are necessary for supplying the city gas, and the costs for piping are relatively high. In spite of such merits of the gas type heating apparatuses, if a heat energy supplier with a heat-power generation facility for heating the water or houses etc, or a centralized common heating facility is available, the city gas consumption might be low and the costs for equipping the city gas supply facilities might be uneconomically high. For such reasons, sometimes there have been conflicts between the residents hoping to use the city gas and the city gas supplier because of the supplier's refusal to supply the city gas. In a case that the city gas is used only for cooking, it is inevitable to determine a city gas fee very high to recover investments for the supply facilities even when the city gas supply is possible. It has happened sometimes that the actual supply cost for such consumers is as 5 times or higher as for consumers using for heating.

In spite of that, the reason that typical electric cooking apparatuses using an electric heating element are not widely used is their low efficiency of heat transfer from the electric heating element to a cooking utensil. In the conventional electric heating apparatuses for cooking, the heat from a heating element is transferred to the cooking utensil by radiation or natural convection and thus the heat transfer coefficient on the outer surface of the cooking utensil is low (There is a very thin gas layer on the outer surface of every rigid body, and the gas layer functions as a thermal insulation layer because a velocity of the gas fluid in the natural convention is very low.). As a result, there are such problems as the heat transfer efficiency is low and the heating time is long with the conventional electric cooking apparatuses.

Besides, due to limitations on radiation rate of the heat from the surface of the electric heating element into the air, the electric heating element has an upper limit of energy radiated per unit length and thus an electric heating wire to be laid in a unit area is limited in length. This is referred to Watt-density and its typical value in the air is 2˜4 W/cm². That is, an electric heating plate with the size of 10 cm×10 cm is capable of generating heat only to the extent of 200˜400 W. Accordingly, if the electric heating element (electric heating wire) is installed in the same area as the conventional electro-thermal cooking apparatus so as to produce 1 kW, the heat generated by the electric heating wire might not be sufficiently radiated into the air and consequently a part of the heat might be accumulated in the wire, which causes the wire to melt down due to overheat.

A cooking apparatus using induction electricity, which is referred to ‘Induction Cooker’, is known as one of the conventional electro-thermal cooking apparatuses, but it has not been widely used because of restrictions on the material and shape of the lower part of the cooking utensils.

Meanwhile, a heating device which uses mixed gas of oxygen and hydrogen obtained by electrolyzing water has been developed. The combustion heat of the hydrogen is as follows:

H₂+O₂→H₂O+241,518 J/mole

The combustion heat can be converted into an energy density to a combusted gas volume as follows after the hydrogen is combusted in air:

in case of H₂→241,518/5=48,304 J/mole

Accordingly, the possibly reachable maximum temperature of the combusted gas is as follows:

in case of H₂→1,500° C.

Furthermore, as the electrolysis devices use a high concentration of alkaline aqueous solution, handling the material is strict. It might be very difficult to prevent a backfire of the mixture gas (oxygen+hydrogen) obtained by the electrolysis because it might be easily ignited on its way to a combustion nozzle.

### DISCLOSURE

### Technical Object

It is an object of the present invention to provide an apparatus for generating compound plasma of hydrogen and oxygen obtainable from a raw material of water vapor which is economical, efficient, and secure energy, and does not generate contaminants, and a method of generating the compound plasma using the apparatus.

It is another object of the present invention to provide an electro-thermal cooking method which has good heat transfer efficiency much higher than the conventional gas or electric type heating methods and is capable of reducing the heating time, and an electro-thermal cooking apparatus therefore.

It is still another object of the present invention to provide an electro-thermal cooking apparatus and method using compound plasma which is allowed to be relatively free in arrangement and shape of a heater with a power source.

It is still another object of the present invention to provide an electro-thermal cooking apparatus and method using compound plasma in which maintenance such as carrying, storing, and using the fuel material, and preventing backfire can be done easily.

It is still another object of the present invention to provide an electro-thermal cooking apparatus which is capable of being securely used, and an electro-thermal cooking method therefor.

It is still another object of the present invention to provide an electro-thermal cooking apparatus which can reduce the costs for constructing and fuel-consuming, and an electro-thermal cooking method.

It is still another object of the present invention to provide an electro-thermal cooking apparatus which can minimize the environmental contamination.

### Technical Solutions

According to one aspect of the present invention to achieve its object as above, there is provided an apparatus for generating compound plasma including an insulating tube at least having the top opened; a blast nozzle, installed in the inside of the insulating tube, for blasting water vapor toward the opened top of the insulating tube; and an electric discharge means, installed in the inside of the insulating tube, for making the water vapor electrically discharged by applying strong energy to the water vapor blasted from the blast nozzle so as to convert the water vapor into compound plasma of hydrogen plasma and oxygen plasma.

According to an exemplary constitution, the electric discharge means has a coil winding around the insulating tube and surrounding the water vapor blasted from the insulating tube; and a power supply for supplying the coil with high frequency electric power to make high frequency induction discharge happen in the water vapor so as to convert the water vapor into the compound plasma.

According to another exemplary constitution, the electric discharge means comprises a first discharge electrode and a second discharge electrode arranged at different positions of the insulating tube; and a power supply for supplying the first discharge electrode and the second discharge electrode with DC or AC power to make an arc discharge happen in the water vapor blasted, wherein the water vapor is converted into the compound plasma by the arc discharge.

It is preferable that the apparatus for generating compound plasma further includes a dilution fluid supply for supplying the inside of the insulating tube with dilution fluid to control temperature of the compound plasma. By means of it, it can be prevented that temperature of the compound plasma goes excessively high. The dilution fluid comprises at least any one among water vapor, air, and water.

It is preferable that the apparatus for generating compound plasma further includes an evaporator for converting water into water vapor by means of an electric power and providing the blast nozzle with the water vapor. In this case, it is preferable that the apparatus further includes an electric conductivity sensor for measuring an electric conductivity of the water in the evaporator; and a control means for controlling concentration of electrolyte contained in the water in the evaporator so as not to exceed a predetermined value based on the information measured by the electric conductivity sensor. The control means, according to an exemplary constitution, includes a water drainage for draining non-vaporized concentrated water out of the evaporator; a water supply for supplementing the water drained out from the evaporator; a water level sensor for measuring a level of the water in the evaporator; and a controller for controlling amount of water fed from the water supply based on information of the level of the water from the water level sensor. Preferably, the evaporator converts the water into water vapor in an electrically heating method.

In order to properly control temperature, it is preferable that the apparatus for generating compound plasma further includes a temperature sensor for measuring temperature of the compound plasma; and a control means for controlling at least any one among strength of electric energy applied by the electric discharge means to the water vapor, quantity of the water vapor blasted from the blast nozzle, and amount of the dilution fluid added to the compound plasma, based on the measured temperature from the temperature sensor, in order to make the temperature of the compound plasma kept within a set range.

Meanwhile, according to one aspect of the present invention to achieve its object as above, there is provided an electro-thermal cooking apparatus including an evaporator for generating water vapor by heating water therein with electric energy; a blast nozzle for blasting the water vapor supplied from the evaporator; and an electric discharge means, installed in an insulating body around the blast nozzle, for making the water vapor electrically discharged by applying strong energy to the water vapor blasted from the blast nozzle so as to convert the water vapor into compound plasma of hydrogen plasma and oxygen plasma, wherein the compound plasma is used as an energy transfer medium for a cooking utensil.

It is preferable that the electro-thermal cooking apparatus further includes a temperature control unit having a dilution fluid supply for adding a dilution fluid to the compound plasma to control temperature of the compound plasma. Furthermore, it is also preferable that the electro-thermal cooking apparatus further includes a temperature sensor for measuring temperature of the compound plasma; and a control unit for controlling the temperature control unit based on the measured temperature from the temperature sensor so as not to allow temperature of the compound plasma to go out of a predetermined range. Here, it is possible to use at least any one among water, water vapor and air as the dilution fluid.

Preferably, the evaporator includes a water drainage for draining out non-vaporized concentrated water in the evaporator. In that case, the electro-thermal cooking apparatus may further include a water supply for supplementing water drained out from the evaporator; a water level sensor for measuring a level of the water in the evaporator; and a controller for controlling amount of water fed from the water supply based on information of the level of the water from the water level sensor.

It is also preferable that the electro-thermal cooking apparatus further includes an electric conductivity sensor for measuring electric conductivity of the water in the evaporator; and a controller for controlling the water drainage to drain the concentrated water in the evaporator in order not to allow concentration of the electrolyte contained in the water in the evaporator to exceed a predetermined value, based on the measured value from the electric conductivity sensor.

In the electro-thermal cooking apparatus, an embodiment of the electric discharge means includes a first discharge electrode and a second discharge electrode arranged at different positions of the insulating tube; and a power supply for supplying the first discharge electrode and the second discharge electrode with DC or AC power to make an arc discharge happen in the water vapor blasted, wherein the water vapor is converted into the compound plasma by the arc discharge. Another embodiment of the electric discharge means includes a coil winding around the insulating tube and surrounding the water vapor blasted from the insulating tube; and a power supply for supplying the coil with high frequency electric power to make high frequency induction discharge happen in the water vapor so as to convert the water vapor into the compound plasma.

Preferably, the electro-thermal cooking apparatus may further include a timer for setting a permitted use time of the cooking apparatus in order to automatically shut off power supply when an elapsed operation time of the cooking apparatus exceeds the permitted use time.

In the meantime, according to still another aspect of the present invention to achieve the above-mentioned object, there is provided a method of generating compound plasma, including the steps of: blasting water vapor through a blast nozzle; and converting the water vapor into compound plasma of hydrogen plasma and oxygen plasma by applying strong electric power to the water vapor blasted from the blast nozzle so as to make the water vapor electrically discharged.

Preferably, the method of generating compound plasma may further include the step of controlling temperature of the compound plasma within a desired temperature range by adding a dilution fluid to the compound plasma. Here, any one selected from the group of water vapor, water, and air may be used as the dilution fluid.

It is preferable that the method of generating compound plasma may further include the steps of measuring temperature of the compound plasma; and controlling at least any one among strength of electric energy added to the water vapor, quantity of the water vapor blasted from the blast nozzle, and amount of the dilution fluid added to the compound plasma, based on the measured temperature in order to make temperature of the compound plasma kept within a set range.

Preferably, the method of generating compound plasma may further include the step of converting water into water vapor by electrically heating the water and supplying the water vapor as a raw material for generating the compound plasma. Furthermore, it is preferable that the method of generating compound plasma may further include the steps of measuring electric conductivity of the water in an evaporator while heating the water contained in the evaporator; and controlling concentration of the electrolyte contained in the water in the evaporator based on the measured electric conductivity so that the concentration of the electrolyte cannot exceed a predetermined value. Moreover, it is preferable that the electrolyte concentration control step may include the steps of draining non-vaporized concentrated water from the evaporator when the concentration of the electrolyte contained in the water of the evaporator exceeds a predetermined value; and supplementing the evaporator with water. It is also preferable that the method of generating compound plasma may further include the steps of measuring temperature of the compound plasma and shutting off electric power supply for the generation of the compound plasma.

### Advantageous Effects

The present invention can raise the heat transfer efficiency by using the compound plasma of a high temperature and a relatively high energy density in spite of employing the electric heating method, and it can make the heating time shortened with a downsized heating apparatus though.

Besides, the present invention can provide relatively much freedom in designing arrangement of elements and shape, including power supply, of the electro-thermal cooking system using the compound plasma.

The present invention also provides easiness in managing transportation, storage, use, and antibackfire of fuel by replacing relatively dangerous fuel such as LPG, LNG, and kerosene with water which is safe.

When earthquake or fire happens, the electro-thermal cooking system according to the present invention is safer than the case of using the city gas as fuel because the present invention can allow little gas to leak out.

Furthermore, if the present invention is used, there is no need of separately installing the facilities such as gas pipes and thus costs for configuring the electro-thermal cooking system and using the fuel can be lowered.

The present invention can minimize environmental pollution by suppressing generation of harmful gases such as CO or CO₂ gas.

### BRIEF DESCRIPTIONS OF DRAWINGS

FIG. 1 is a block diagram which shows a functional constitution of an electro-thermal cooking apparatus using compound plasma, in accordance with an embodiment of the present invention;

FIG. 2 is a flowchart for a temperature control in the electro-thermal cooking apparatus shown in FIG. 1;

FIG. 3 is a flowchart for controlling concentration of electrolyte in the water contained in an evaporator;

FIG. 4 illustrates an exemplary constitution of the blast nozzle shown in FIG. 1; and

FIG. 5 illustrates another exemplary constitution of the blast nozzle shown in FIG. 1.

### BEST MODE

Hereinafter, the present invention will be described in detail with reference to the attached drawings.

If a heating apparatus for cooking uses electricity as its energy source, it would be very economical because no extra money is needed for installing power supply utilities. Besides, no greenhouse gas comes out during its use and a thermal energy conversion rate is also very high. It may be really great if heat transfer efficiency could be increased.

A method capable of improving the heat transfer efficiency is to make a high temperature fluid flown at a high speed along the outer surface of the object to be heated such as a cooking utensil. By doing so, a thin stagnant layer is hardly formed along the outer surface of the cooking utensil and as a result the heat transfer efficiency is improved because the stagnant layer functions as a heat insulation layer due to its low efficiency of heat transfer and thus is a main cause of lowering the heat transfer efficiency.

For the method, an energy transfer medium in a state of high speed fluid is necessary. Water vapor or air is the most suitable material for the medium of fluid state as it is safe and non-polluting. (For methane and propane gas which are typical gases for combustion, water vapor or CO₂ gas plays the role of energy transfer medium. But CO₂ is a main cause of a greenhouse effect.) However, the water vapor or air is not suitable for using as a heating source for cooking because it can transfer only a little amount of energy due to its small capability of energy carrying per unit amount of fluid. If these materials are converted into plasma and used as an energy transfer medium, the heat transfer efficiency can be increased. For example, if water vapor is electrolyzed into compound plasma (plasma of hydrogen ions and oxygen ions) of high temperature and the compound plasma is used as the energy transfer medium, high efficiency of heat transfer could be achieved regardless of the shape or material of the cooking utensils.

As the temperature of the ‘compound plasma’ is usually over 6,000° C., energy density of a fluid of energy transfer medium which makes contact with the cooking utensil is high. Besides, the fluid itself directly passes along the surface of the cooking device and thus it provides high efficiency of heat transfer. When ‘compound gas’ of hydrogen and oxygen obtained from water electrolysis burns, its energy density is low such that temperature at the center of flare is about 1,000˜1,500° C. That is, energy density of the compound plasma is 4 times or more as high as the ‘compound gas’ of hydrogen and oxygen. Such degree of the energy density is higher than or equal to that of the city gas or propane gas. The heating time can be shortened even in the case that a heating device is downsized.

The present invention uses a high temperature fluid such as the compound plasma as a heat source, that is, an energy transfer medium to heat an object to be heated. Water (water vapor) is used as a preferable raw material for producing the compound plasma. If electrical energy is applied to the water, it is electrolyzed into hydrogen and oxygen which forms an environment of the compound plasma of them. The compound plasma of hydrogen plasma and oxygen plasma has a high level of thermodynamic energy. In the cooking apparatus of the present invention, it transfers heat to the object to be heated. The compound plasma may have an excessively high temperature depending on a structure of the cooking apparatus generating it. In that case, the cooking apparatus may be constituted such that a gas for dilution (ex: water vapor or air) is added to the compound plasma to lower temperature of the compound plasma to a desired level before transferring heat to the cooking utensil.

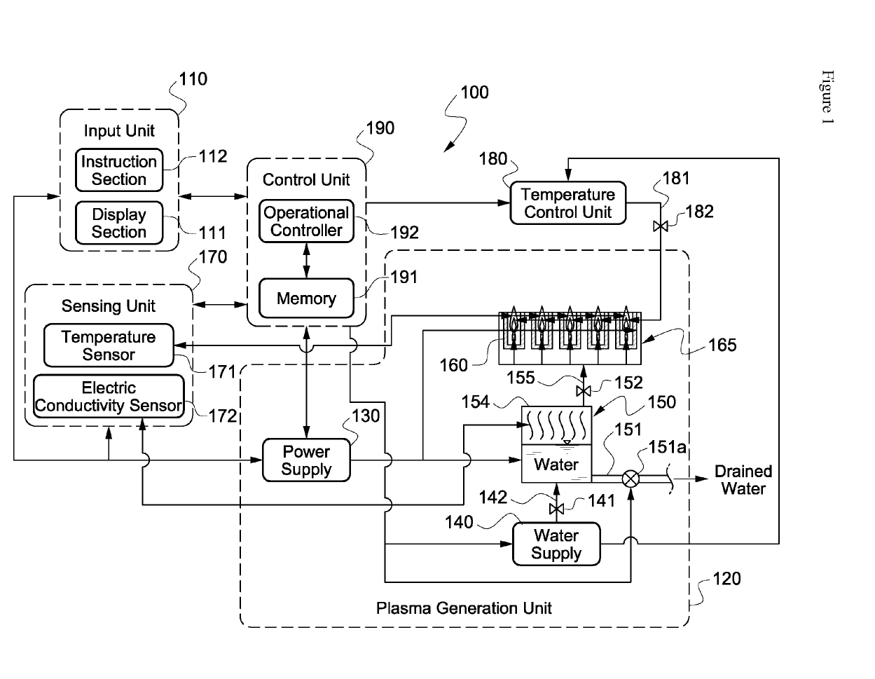

FIG. 1 illustrates an electro-thermal cooking apparatus 100 which is configured, based on such basic concepts, for producing ‘compound plasma’ of high temperature at an atmospheric pressure. As being equipped with a blast nozzle from which a fluid is discharged, the electro-thermal cooking apparatus 100 is constructed such that a high temperature fluid has direct contacts with the objects to be heated such as a cooking pot, a fly fan, a cattle, and so on, which makes a heat transfer coefficient large and accordingly improves the heat transfer efficiency. For this, the electro-thermal cooking apparatus 100 has a plasma generation unit 120 for producing the compound plasma and heating the objects to be heated. In addition, the electro-thermal cooking apparatus 100 may include an input unit 110, a sensing unit 170, a temperature control unit 180, and a control unit 190.

Firstly, the plasma generation unit 120 will be described. The plasma generation unit 120 applies electric energy to water in a vapor state, which is a raw material, to generate the compound plasma of hydrogen and oxygen which serves as a medium for transferring heat energy to the object to be heated. As shown in FIG. 1, the plasma generation unit 120 has a power supply 130, a water supply 140, an evaporator 150, and a plasma generator 165.

Water in gas state (that is, water vapor) is necessary to generate the compound plasma. The water vapor may be supplied from outside of the electro-thermal cooking apparatus 100, but it is more preferable that the cooking apparatus 100 is equipped with a water vapor generation means for converting the water into the water vapor.

In FIG. 1, the water vapor generation means is illustrated. The water vapor generation means has the evaporator 150. As widely known, there are two methods for converting water into water vapor: one is the method to raise a temperature (‘heating method’) and the other is the method to lower a pressure (‘depressurization method’). Either of them can be applied to the present invention, but the heating method is simpler and more cost-effective than the depressurization method. An electric heating method is a simple one in the heating methods. There are several kinds of the electric heating method. Applicable methods to the present invention are, for example, a resistance heating method which uses the Joule's heat generated by a resistor through which current flows; an induction heating method which uses the heat generated by the hysteresis loss or eddy current loss in a conductor located in an AC magnetic field (high frequency heating is an example of this method); and a microwave heating method which produces water vapor by making water molecules vibrated with microwaves. Besides, an arc heating method, a dielectric heating method, an infrared heating method, an electron beam, or laser beam heating method is also applicable to the present invention. As these methods are well-known, detailed descriptions about them would not be given here.

For example, in the evaporator 150 configured in the resistance heating method, a resistor is buried in the bottom of an evaporator container 154 which can contain water of about 50-500 cc. If a current flows through the resistor, then the water is heated and converted into the water vapor. The evaporator container 154 is connected with a vapor supply pipe 155 which extends to each of the blast nozzle sections 160. In the vapor supply pipe 155, a vapor discharge valve 152 is installed. If a user gives instructions to the control unit 190 through the input unit 110 such that quantity of the water vapor supplied to each of the blast nozzle sections 160 can be controlled, the control unit 190 controls the vapor discharge valve 152 to adjust the amount of the water vapor supplied to each of the blast nozzle sections 160. As another example, if the quantity of the water vapor to be supplied to the blast nozzle sections 160 could be easily controlled, the vapor discharge valve 152 might not be required. Preferably, the evaporator container 154 may have a water level adjustor, an inlet water quantity controller, and a water vapor discharging quantity controller.

The water contained in the evaporator container 154 is vaporized into the water vapor by being heated and the generated water vapor is supplied to each of the blast nozzle section 160 via the vapor supply pipes 155. Supplying electric power required for vaporizing water into water vapor may be implemented either in the evaporator 150 or out of the evaporator 150.

The water vapor generation means may further include a water supply 140 for stably supplying the evaporator 150 with required amount of water. As the water is continuously consumed in the evaporator 150 during operation of the cooking apparatus 100, it is required to supply the water continuously or intermittently to the evaporator 150 in the amount as much as it is reduced. Supplying the evaporator 150 with the water required for generating the water vapor may be done manually by a user, but it is also possible to supply water with a constitution in which the water supply 140 connected to the evaporator container 154 is separately prepared and the water from the water supply 140 is forced to be supplied at a predetermined pressure (about 1 kPa or more). The water supply 140 may be connected to, for example, water-supply facilities (not shown) such as water pipes to feed the water to the evaporator 150. As shown in FIG. 1, the water supply 140 may include a water feed valve 141 installed in the water feed pipe 142 which is connected to the evaporator 150. In such configuration, if the user instructs the control unit 190 via the input unit 110 to control the quantity of water to be supplied to the evaporator 150, the control unit 190 would control the water feed valve 141 and the quantity of water fed to the evaporator 150 can be controlled by the valve control.

In the water supplied to the evaporator 150, only pure water is vaporized and electrolytes in the water are left out without being vaporized. Thus the non-vaporized remaining water (enriched water) for a long time in the evaporator 150 contains a large amount of the electrolytes. If the enriched water is not discharged, the electrolytes may be precipitated on electrodes for electrolysis or on the surface of the evaporator 150, which may be the causes of performance down of the evaporator 150. Therefore it is preferable that at least a part of the water in the evaporator 150 should be discharged out in a liquid state and be exchanged with new fresh water to prevent the electrolytes from being precipitated from the water. In determining (controlling) the water quantity to be discharged, electric conductivity (inverse value of electric resistance) of the evaporator 150 and/or the blast nozzle section 160 is measured and controlled so as not to go beyond a predetermined limit value in order to adjust concentration of the electrolytes. The concentration of the electrolytes can be adjusted by controlling the electric conductivity because an electric conduction phenomenon in the water is proportional to the concentration (normal concentration) of ions from ionization of the electrolytes. By doing so, it is possible to prevent the electrolytes from being deposited on the evaporator 150 and/or the blast nozzle section 160.

The reasons are as follows. In the evaporator 150, the following equations are established among quantity F of fed water, concentration C_{F} of electrolytes in the fed water, quantity C_{V} of vaporized (or electrolyzed) water, quantity D of drained water, and concentration C_{D} of electrolytes in the drained water. In addition, concentration C_{C} of electrolytes in the evaporator 150 is substantially equal to concentration C_{D} of electrolytes in the drained water because concentration C_{C} of electrolytes in the evaporator 150 is almost uniform regardless of position. Therefore, the following Mass Balance equations are established:

$$F = V + D \\ F \cdot {C}_{F} = V \cdot {C}_{V} + D \cdot {C}_{D} \\ {C}_{C} = {C}_{D} \\ R = \frac{D}{F} \qquad ( 1 )$$

In the above equations, R is a discharge rate (ratio of the discharged water to the fed water).

As only pure water is vaporized or electrolyzed, the electrolytes are not included in the flow of precipitation or electrolysis. That is, C_{V}=0.

Accordingly, the above equation (1) can be written as follows:

$${C}_{C} = \frac{F}{D} \times {C}_{F} \\ {C}_{C} = \frac{1}{R} \times {C}_{F} \qquad ( 2 )$$

According to the equation (2), concentration of the electrolytes in the evaporator 150 is inversely proportional to a discharge rate. That is, R=0 and C_{C} is infinite when there is no discharge, and thus all the electrolytes are accumulated and precipitated on the evaporator 150.

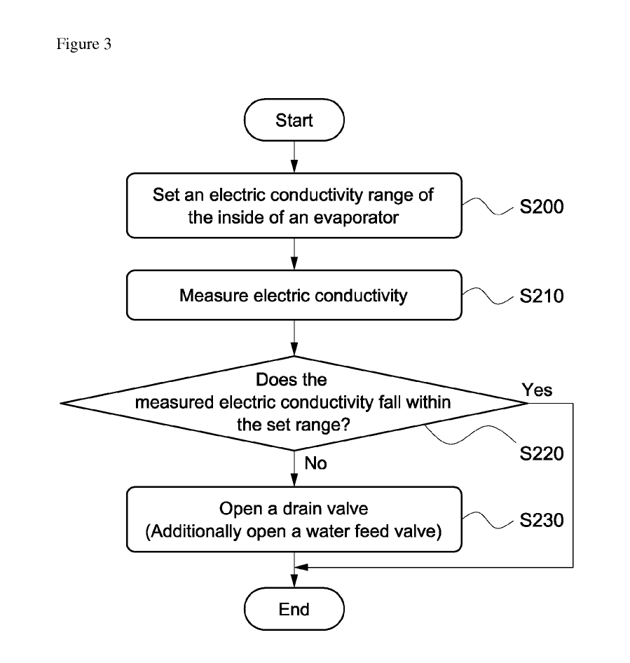

In order to hold back deposition of the electrolytes in the evaporator 150, preferably the water vapor generation means may further include a water drainage 151. The water drainage 151 is arranged at a part of the evaporator 150 so that the non-vaporized water (enriched water) among the water contained in the evaporator 150 can be drained out. Of course, the water supply 140 is required to feed water into the evaporator 150 to supplement the amount of drained water from the evaporator 150 and such control of feeding the water can be performed by the control unit 190 and a water lever sensor (described below). As shown in FIG. 1, the water drainage 151 may be made, for example, in a form of a discharge pipe connected to the evaporator 150. It is preferable that a drain valve 151a is installed in the discharge pipe. It is also preferable that the drain valve 151a is controllable with the control unit 190 so as to adjust the concentration of the electrolytes contained in the water of the evaporator 150. Such configuration prevents the electrolytes contained in the water of the evaporator 150 from being deposited on the electrodes of the power supply 130 or the inside of the evaporator 150, where their performance would be degraded due to the deposition of the electrolytes. That is, the electric conductivity in the water is proportional to concentration of ions ionized from the electrolytes (normal concentration), and thus the concentration of the electrolytes can be adjusted by controlling the electric conductivity as shown in FIG. 3.

Meanwhile, the plasma generator 165 includes one or more blast nozzle sections 160. Preferably, the number of the blast nozzle sections 160 is about three or more, and they are spaced apart by the same distance so as to uniformly heat the bottom of the cooking utensil. The water vapor fed from the evaporator 150 is blasted out through each of the blast nozzle sections 160, and the blasted vapor is supplied with electric energy and is converted into the compound plasma of hydrogen and oxygen. The compound plasma generated from the blast nozzle sections 160 is a kind of high temperature fluid and makes the object above the blast nozzle sections 160 heated. Particularly, the compound plasma flows out at a relatively high velocity along the outer surface of the object to be heated such as a cooking pot, and thus no heat insulation layer is formed on the outer surface of the object.

A heat transfer coefficient h of gas flowing along the surface of a rigid body increases as velocity of the gas V_{g} increases (h is approximately proportional to V_{g}⁸. For this, refer to below equation (3)).

$$( \frac{h}{{C}_{p} G} ) \cdot {( \frac{{C}_{p} μ}{k} )}^{2 / 3} = 0.023 \cdot {( \frac{{D}_{e} {V}_{g} ρ}{μ} )}^{- 0.2} \\ G = \frac{π {D}_{e}^{2} ρ {V}_{g}}{4} \\ ∴ h ∝ {V}_{g}^{0.8} \qquad ( 3 )$$

where h=heat transfer coefficient (cal/m²·° C.·sec)
V_{g}=velocity of gas (m/sec)
Cₚ=specific heat of gas (cal/kg° C.)
G=mass flux of gas (kg/m²·sec)
Dₑ=equivalent diameter of gas flow passage (m)
μ=viscosity of gas (N·sec/m²)
ρ=density of gas (kg/m³)

Accordingly, heat transfer efficiency in a case that the heat is transferred to the cooking utensil by means of the (heated or combusted) high temperature gas fast blasted from the blast nozzle sections 160 is much higher than the heat transfer efficiency in a case that the velocity of a flowing gas is low such as the conventional electric cooking apparatus.

A method using a high frequency induction discharge and a method using arc discharge of DC or AC are known as the method for generating the compound plasma. Configuration and structure of the blast nozzle sections 160 may depend on the method by which the compound plasma is generated. However, once the water vapor is used as a raw material, each of the blast nozzle sections 160 is connected to evaporator 150 via the vapor supply pipe 155 and the water vapor supplied from the evaporator 150 should be fed into the blast nozzle sections 160.

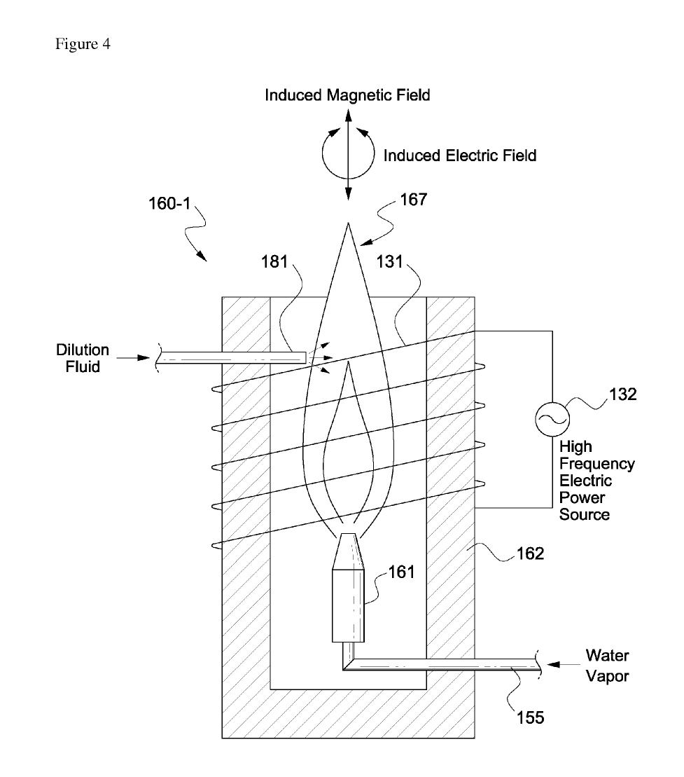

FIG. 4 illustrates detailed constitution of a blast nozzle section 160-1 for a high frequency induction discharge. The blast nozzle section 160-1 has at least one discharge nozzle 161, a tube 162 surrounding the discharge nozzle 161 to form a space therebetween, and an induction coil 131 wound at least several turns on the outer wall of the tube 162. The discharge nozzle 161 is connected with the end of the water vapor pipe 155 which extends into the inner space of the tube 162. The top of the tube 162 is opened in order for the generated plasma to be discharged therethrough. As a result, the induction coil 131 encircles the blast nozzle 161 and water vapor fluid blasted from the blast nozzle 161. Preferably, the tube 162 may be made of an insulation material such as quartz or ceramics. A high frequency power source 132 of, for example, 100 Khz-100 Mhz is connected to the induction coil 131 via an impedance matching circuit.

With such constitution, when a high frequency current flows in the induction coil 131, a time varying magnetic field of the same frequency is induced in a vertical direction, and subsequently a time varying electric field is also induced in an azimuthal direction surrounding the magnetic field. The induced electric field breaks insulation of the water vapor injected into the inner space of the blast nozzle section 160-1 while inducing a circular current in an opposite direction to the current of the induction coil 131. Consequently, electric discharge arises in the water vapor and high temperature plasma is produced. Because of a high electric conductivity of the plasma and a skin effect by the magnetic field of high frequency, the induced electric field distribution and the resultant temperature distribution of the plasma 167 generated by the Ohmic resistance heating take a pattern of radial distribution that their peak values are slightly biased from the central axis of the tube 162 to the wall of the tube 162, and form a flame of annular shell type. Such induction discharge of high frequency is an electrode-free type discharge.

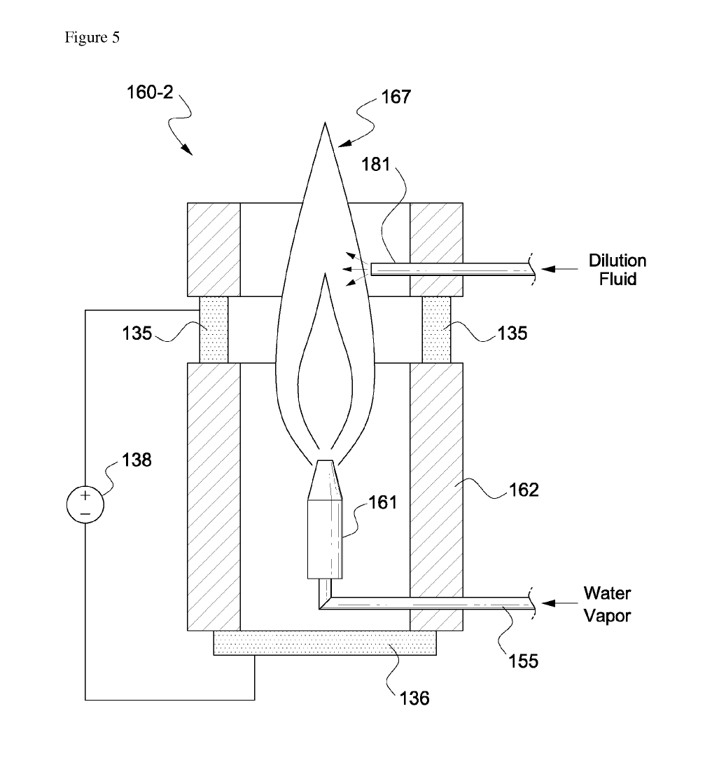

Next, FIG. 5 illustrates the constitution of a blast nozzle section 160-2 using DC or AC arc discharge. The blast nozzle section 160-2 has a lower electrode 136 and an upper electrode 135 in its lower part and upper part, respectively. DC or AC power source 138 is applied across the upper and lower electrodes 135 and 136. The blast nozzle section 160-2 also has a discharge nozzle 161 which is connected to the end of vapor supply pipe 155 extending to the inside of the tube 162.

In such constitution, the blast nozzle section 160-2 converts the water vapor injected from the blast nozzle 161 into the compound plasma 167 of hydrogen and oxygen by means of the DC or AC arc discharge between the electrodes.

As shown in FIG. 1, the power supply 130 supplies an electric power to the respective elements of the electro-thermal cooking apparatus 100 such as the input unit 110, the sensing unit 170, the control unit 190, and the plasma generation unit 120. If the evaporator 150 is an electrically heating type which heats the water with the electric power, the power supply 130 should supply the electric power to the evaporator 150. As described above, to convert the water vapor into the compound plasma the power supply 130 may also supply the blast nozzle section 160 with either the high frequency power source 132 for the high frequency induction discharge or DC or AC power source 138 for the arc discharge relying on its heating type. The users may control wattage with the input unit 110. The case that the electric power is used for the energy source of the electro-thermal cooking apparatus 100 would be more effective in terms of the costs of materials and fuel than the case that gas is used for the same purpose (Extra costs for constructing utilities for gas supply such as gas pipes and so on are needed when gas is used as the energy source).

In the meantime, the input unit 110 is a user interface means and includes a display section 111 and an instruction section 112. The instruction section 112 has a user input means with which users can do several works such as giving his or her instructions (for example, recipes or operation modes) on the operations of the cooking apparatus 100, setting target values with respect to heating temperature, operation time of the cooking apparatus 100 and a range of the desired electric conductivity (inverse of the electric resistance) in the evaporator 150, and ordering user's directions. The display section 111 has a display for showing descriptions or messages related to the operations or states of the cooking apparatus 100, ranges of the permitted use temperature, and electric conductivity, real-time values of electric power and power consumption of the cooking apparatus 100. The input unit 110 transfers the user's instructions and the target values set by the user to the control unit 190. Therefore, users can select desired ones from a variety of recipes and modify them. They can check the electric power consumption and costs in real-time and thus they can pay more attention to saving electric charges.

Regardless of the configurative type of the blast nozzle section 160, the compound plasma produced in the plasma generator 165 is a high temperature fluid of about 6,000° C.-10,000° C. Using directly so hot plasma as the heat transfer fluid may cause damages or deformation of the cooking utensils due to its excessively high temperature. Accordingly, it is preferable to use the compound plasma along with a fluid for dilution (dilution fluid), rather than to use the compound plasma alone as it is.

The materials such as water, water vapor, and air can be used as the dilution fluid. The air is advantageous in that it is abundant enough and can be used for free, but it has a disadvantage that it may produce NOx because of nitrogen in the air when it contacts the compound plasma of high temperature. To avoid such demerit, it is preferable to use water (in liquid) or water vapor as the dilution fluid.

The electro-thermal cooking apparatus 100 may further include a temperature control unit 180 which controls temperature of the plasma 167 to a desired level by adding the dilution fluid to the hot compound plasma 167. The temperature control unit 180 includes a dilution fluid supply pipe 181 which extends to the inside of the blast nozzle section 160-1 or 160-2 to add the dilution fluid to the compound plasma as shown in FIG. 1. The dilution fluid supply pipe 181 is a pipe extending toward each blast nozzle of the blast nozzle section 160 and provides the compound plasma with the dilution fluid. Preferably, it is preferable to further install a dilution control valve 182 at a position in the dilution fluid supply pipe 181 to control addition of the dilution fluid. The control unit 190 can control the heat transferred to the to-be-heated object by means of the compound plasma by controlling the dilution control valve 182. That is, the heat transferred via the compound plasma can be controlled by the control unit 190 which controls ON/OFF of the dilution control valve 182 based on the measured temperature by the temperature sensor 171. Due to such temperature control function, the users can select various kinds of recipes and modify them beyond the object of preventing an over-heated state.

Alternatively, water vapor can be also used as the dilution fluid (gas). For this, separate dilution vapor supply pipes (not shown) may be installed between the temperature control unit 180 and the blast nozzle section 160-1 or 160-2 and between the evaporator 150 and the blast nozzle section 160-1 or 160-2, and a control valve (not shown) may be installed in the dilution vapor supply pipes. In that case, the temperature control unit 180 may not be provided and the control unit 190 may directly control the power supply 130 and the vapor discharge valve 152 to control temperature of the compound plasma to be maintained within a temperature range set by the users.

Water could be used as another preferable dilution fluid because it will be evaporated in a moment into water vapor when the water is added to the compound plasma. In that case, a portion of the water supplied to the evaporator 150 from the water supply 140 can be bypassed to the temperature control unit 180 as shown in FIG. 1. Alternatively, a portion of the water contained in the evaporator 150 can be bypassed to the temperature control unit 180 (not shown).

It is preferable to add the dilution fluid to the upper part (downstream) of the compound plasma. In that case, the lower part (upstream) of the compound plasma to which no dilution fluid is added still maintains its temperature high (5,000˜6,000° C. or more), whereas the compound plasma's downstream (upper part) of the point to which the dilution fluid is added may be not in a state of perfect plasma, but in a state of mixture of ‘a high temperature gas’ and ‘plasma’ or in a state of ‘a high temperature gas’ (Temperature of the mixture of the high temperature gas is determined relying on the added amount of the dilution fluid, and such feature is advantageous in that it is possible to achieve a wide range of temperature as needed).

A portion of the water supplied to the evaporator 150 from the water supply 140 may be bypassed (not shown) toward the blast nozzle section 160 to prevent the electro-thermal cooking apparatus 100 from being overheated. Another method to prevent overheat of the cooking apparatus 100 is to use a timer with which an operation time of the cooking apparatus 100 can be set and a power supply can be shut off when the operation time set elapses. This method will prevent fires due to user's carelessness.

As shown in FIG. 1, the sensing unit 170 preferably includes a temperature sensor 171 for measuring the temperature of the compound plasma and an electric conductivity sensor 172 for measuring the electric conductivity of the water in the evaporator 150. In addition, it is preferable that the sensing unit 170 further includes a water level sensor (not shown) for measuring level of the water contained in the evaporator 150. With the water level sensor, the control unit 190 can control the water supply 140 and/or the water feed valve 142 so as to supply additionally the evaporator 150 with the water or to stop supply of the water.

As shown in FIG. 1, the control unit 190 has a memory 191 for storing necessary programs or several data related to user's instructions or setting and providing a data space needed for a processor's data processing. Furthermore, the control unit 190 has an operational controller 192 for controlling operations of respective elements 110, 120, 130, 179, and 180 of the cooking apparatus 100 based on the user's instructions and setting data, and measured data from the sensing unit 170, etc. For instance, the operational controller 192 reads from the memory 191 data with respect to a permitted temperature range of the cooking apparatus or an electric conductivity range which should be kept in the evaporator 150, where these data are stored in advance in the memory 191. And, the operational controller 192 controls not only the temperature control unit 180 based on the data measured by the temperature sensor 171 but also the water drainage 151 so as to adjust concentration of the electrolyte contained in the water within the evaporator 150 based on the measured data from the electric conductivity sensor 172. The operational controller 192, as an alternative method for controlling the compound plasma, may directly control the power supply 130. In that case, the operational controller 192 can maintain the desired temperature of the compound plasma by directly controlling voltage, current, and feeding time of the electric power source from the power supply 130.

Besides, it is preferable that the electro-thermal cooking apparatus 100 further includes a rack (not shown) on which a cooking utensil is put. Preferably, the rack is structured to secure a gap between the bottom surface of the cooking utensil and the top of the blast nozzle section 160 to prevent direct contact therebetween. Additionally, the rack may be structured detachable for easy washing.

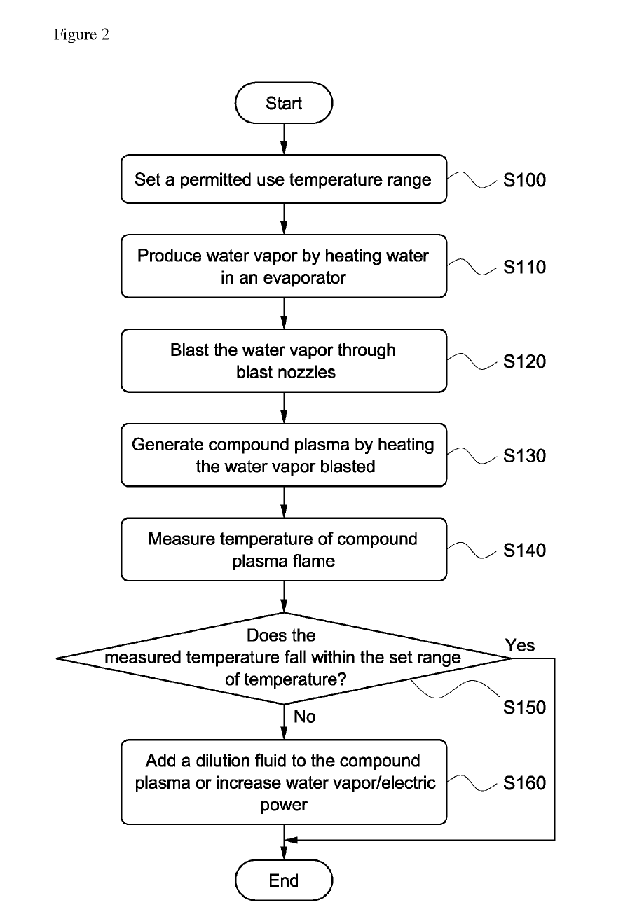

Next, the process for producing the compound plasma with the electro-thermal cooking apparatus 100 will be described with reference to FIGS. 1 and 2. First of all, being fed with an electric power, the power supply 130 supplies the cooking apparatus 100 with electric power such that a real-time state of the cooking apparatus 100 is displayed on the display 111 of the input unit 110 and the elements such as the input unit, the evaporator 150, the sensing unit 170, and the control unit 190 initiate their operations.

In the following step, if the water level sensor of the sensing unit 170 senses the fact that level of the water contained in the evaporator 150 goes beyond a predetermined range, the control unit 190 controls the water feed valve 141 either to be opened for additionally supplying the evaporator 150 with water or to be closed for stopping the water supply.

If a user inputs operation conditions such as recipes, a cooking time, a permitted use temperature, and so on of the cooking apparatus 100 with the input unit 110, the input data of the operation conditions are stored in the memory 191 of the control unit 190 (S100). These data will be used as control bases of the following operations.

The evaporator 150 produces water vapor by heating the water (S110). The produced water vapor is fed to the blast nozzle section 160 and then is blasted through the blast nozzles 161 (S120).

As a strong energy is applied to the above space of the blast nozzle section 160, the water vapor discharged from the blast nozzle section 160 is heated up and converted into the compound plasma of hydrogen and oxygen (S130).

The temperature sensor 171 of the sensing unit 170 measures temperature of the compound plasma generated from the blast nozzle section 160 (S140).

The operational controller 192 of the control unit 190 verifies whether the temperature measured by the temperature sensor 171 falls within the predetermined range or not (S150). If it is determined that the measured temperature in step S150 is within the setup range, no temperature control will be activated.

However, if it is determined that the measured temperature is out of the predetermined range, the control unit 190 will initiate control operations for controlling the temperature of the compound plasma. That is, if the temperature of the compound plasma is higher than the predetermined temperature range, the control unit 190 controls the temperature control unit 180 to increase quantity of the dilution fluid to be added to the compound plasma. Otherwise, the control unit 190 performs the controls for increasing quantity of the water vapor to be supplied from the evaporator 150 to the blast nozzle section 160 or for enhancing the electric energy to be applied to the blast nozzle section 160 (S160).

Meanwhile, the control unit 190 may request the sensing unit 170 to measure temperature of the hot gas of the upper part (downstream) of the compound plasma, and then may control the power supply 130 to shut off power supply based on the measured temperature in order to prevent the to-be-heated objects (cooking utensils) from being over-heated by stopping generating the compound plasma when the measured temperature goes beyond the predetermined temperature range.

By means of such optimized temperature control, the cooking utensils would not be damaged or deformed due to high temperature of the compound plasma. The present invention can improve the heat transfer efficiency by means of using the compound plasma of which temperature is high and of which energy density is relatively high, and can decrease the heating time in spite of downsizing the cooking apparatus.

Hereinafter, process for controlling concentration of the electrolytes in the water contained in the evaporator 150 will be described as follows with reference to FIGS. 1 and 3.

At first, if a user sets a range of electric conductivity to be kept in the evaporator 150 with the input unit, the user's setup data are transferred to the memory 191 of the control unit 190 to be stored therein (S200).

Then, the electric conductivity sensor 172 of the sensing unit 170 measures the electric conductivity of the inside of the evaporator 150 (S210).

The control unit 190 verifies whether the measured value of electric conductivity falls within the user's setup range or not (S220).

If the electric conductivity measured in step S220 is larger than the user's setup range, the control unit 190 makes the drain valve 151a opened to allow the water in the evaporator 150 to be drained out (S230). In the case, it might be necessary to further open the water feed valve 141 to increase the quantity of supplied water. If the electric conductivity measured in step S220 is within the user's setup range, the control step jumps to the end.

Through the process as above, performance down of the cooking apparatus 100 can be prevented because no electrolyte contained in the water of the evaporator 150 is precipitated on the electrodes of the power supply 130 or inside of the evaporator.

### INDUSTRIAL APPLICABILITY

The present invention is widely applicable to the fields requiring for producing plasma. For instance, the present invention can be used not only in manufacturing the electro-thermal cooking apparatus using the compound plasma presented in the embodiments but also in designing a variety of kinds of heating apparatuses for home or industry uses.

1. An apparatus for generating compound plasma, comprising:
a blast nozzle for blasting water vapor in a predetermined direction;
an electric discharge means for making the water vapor electrically discharged so as to convert the water vapor into the compound plasma of hydrogen plasma and oxygen plasma by applying strong electric energy to the water vapor blasted from the blast nozzle; and
a dilution fluid supply means for adding a dilution fluid for temperature drop to the compound plasma generated by the electric discharge in order to control temperature of the compound plasma to a desired temperature.

2. The apparatus for generating compound plasma as claimed in claim 1, wherein the electric discharge means comprises: an insulating tube enclosing the blast nozzle therein; a coil winding the insulating tube to enclose the water vapor blasted from the blast nozzle; and a power supply for supplying the coil with high frequency electric power to make high frequency induction discharge happen in the water vapor, wherein the water vapor is converted into the compound plasma.

3. The apparatus for generating compound plasma as claimed in claim 1, wherein the electric discharge means comprises: an insulating tube enclosing the blasting nozzle therein; a first discharge electrode and a second discharge electrode arranged at different positions of the insulating tube, respectively; and a power supply for supplying the first discharge electrode and the second discharge electrode with DC or AC power to make electric discharge happen therebetween, wherein the electric discharge is developed into arc discharge in the water vapor blasted from the blast nozzle and the water vapor is converted into the compound plasma.

4. (canceled)

5. The apparatus for generating compound plasma as claimed in claim 1, wherein the dilution fluid is one selected from the group consisting of water vapor, air, and water.

6. (canceled)

7. (canceled)

8. (canceled)

9. The apparatus for generating compound plasma as claimed in claim 1, wherein the control means comprises: an evaporator for converting water into water vapor and providing the blast nozzle with the water vapor; a water drainage for draining non-vaporized concentrated water out of the evaporator; a water supply for supplementing the water drained out from the evaporator; a water level sensor for measuring a level of the water in the evaporator; and a controller for controlling amount of water fed from the water supply based on information of the level of the water from the water level sensor.

10. The apparatus for generating compound plasma as claimed in claim 1, further comprising: a temperature sensor for measuring temperature of the compound plasma and/or compound fluid to which the dilution fluid is added; and a control means for controlling at least any one among strength of electric energy applied to the water vapor by the electric discharge means, quantity of the water vapor blasted from the blast nozzle, amount of the dilution fluid added to the compound plasma, and whether electric power supply to the electric discharge means should be shut off or not, in order to keep the temperature of the compound plasma and/or compound fluid to which the dilution fluid is added within a set range, based on the temperature measured by the temperature sensor.

11. An electro-thermal cooking apparatus using compound plasma, comprising:
an evaporator for converting water therein into water vapor;
a blast nozzle for blasting the water vapor supplied from the evaporator;
an electric discharge means for making the water vapor electrically discharged so as to convert the water vapor into compound plasma of hydrogen plasma and oxygen plasma by applying strong energy to the water vapor blasted from the blast nozzle; and
a dilution fluid supply means for adding a dilution fluid for temperature drop to the compound plasma generated by the electric discharge in order to control temperature of the compound plasma to a desired temperature,
wherein the compound plasma is usable as an energy transfer medium for a cooking utensil.

12. (canceled)

13. The electro-thermal cooking apparatus using compound plasma as claimed in claim 11, further comprising: a temperature sensor for measuring temperature of the compound plasma and/or compound fluid to which the dilution fluid is added; and a control means for controlling at least any one among strength of electric energy applied to the water vapor by the electric discharge means, quantity of the water vapor blasted from the blast nozzle, amount of the dilution fluid added to the compound plasma, and whether electric power supply to the electric discharge means should be shut off or not, in order not to allow the temperature of the compound plasma and/or compound fluid to which the dilution fluid is added to go out of a set range, based on the temperature measured by the temperature sensor.

14. The electro-thermal cooking apparatus using compound plasma as claimed in claim 11, wherein the dilution fluid includes at least any one out of water vapor, air, and water.

15. (canceled)

16. The electro-thermal cooking apparatus using compound plasma as claimed in claim 11, further comprising: a water supply for supplementing water drained out from the evaporator; a water level sensor for measuring a level of the water in the evaporator; and a controller for controlling amount of water fed from the water supply based on information of the level of the water from the water level sensor.

17. The electro-thermal cooking apparatus using compound plasma as claimed in claim 11, further comprising: an electric conductivity sensor for measuring electric conductivity of the water in the evaporator; and a controller for controlling the water drainage to drain the concentrated water in the evaporator in order not to allow concentration of the electrolyte contained in the water in the evaporator to exceed a predetermined value, based on the measured value from the electric conductivity sensor.

18. (canceled)

19. The electro-thermal cooking apparatus using compound plasma as claimed in claim 11, wherein the electric discharge means comprises: an insulating tube enclosing the blast nozzle therein; a coil winding the insulating tube to enclose the water vapor blasted from the blast nozzle; and a power supply for supplying the coil with high frequency electric power to make high frequency induction discharge happen in the water vapor so that the water vapor is converted into the compound plasma.

20. The electro-thermal cooking apparatus using compound plasma as claimed in claim 11, further comprising a timer for setting a permitted use time of the cooking apparatus in order to automatically shut off power supply when an elapsed operation time of the cooking apparatus exceeds the permitted use time.

21. (canceled)

22. A method of generating compound plasma, comprising steps of:
blasting water vapor via a blast nozzle;
converting the water vapor into the compound plasma of hydrogen plasma and oxygen plasma by making the water vapor electrically discharged with application of strong electric energy to the water vapor blasted from the blast nozzle; and
controlling temperature of the compound plasma to a desired temperature by adding a dilution fluid for temperature drop to the compound plasma generated by electric discharge.

23. (canceled)

24. The method of generating compound plasma as claimed in claim 22, wherein the dilution fluid includes at least any one out of water vapor, air, and water.

25. The method of generating compound plasma as claimed in claim 22, wherein the step of controlling the temperature of the compound plasma comprises steps of: measuring temperature of the compound plasma; and controlling at least any one among strength of electric energy applied to the water vapor, amount of the water vapor blasted from the blast nozzle, amount of the dilution fluid added to the compound plasma, and whether electric power supply to the electric discharge means should be shut off or not, in order to make the temperature of the compound plasma and/or compound fluid kept within a set range, based on the measured temperature.

26. The method of generating compound plasma as claimed in claim 22, further comprising a step of converting water into water vapor and supplying the water vapor as a raw material for the generation of the compound plasma.

27. The method of generating compound plasma as claimed in claim 26, further comprising steps of: measuring electric conductivity of the water in an evaporator while heating the water contained in the evaporator; and controlling concentration of the electrolyte contained in the water in the evaporator based on the measured electric conductivity so that the concentration of the electrolyte cannot exceed a predetermined value.

28. (canceled)

29. (canceled)

30. (canceled)

31. The apparatus for generating compound plasma as claimed in claim 1, wherein a downstream part from a dilution fluid addition point of the compound plasma in a flow direction is not in a state of perfect plasma but in a state of high temperature gas or high temperature compound fluid of gas and plasma.

32. (canceled)

33. (canceled)

34. The electro-thermal cooking apparatus using compound plasma as claimed in claim 11, wherein a downstream part from a dilution fluid addition point of the compound plasma in a flow direction is not in a state of perfect plasma but in a state of high temperature gas or high temperature compound fluid of gas and plasma.
